(19) United States
(12) Patent Application Publication
(10) Pub. No.: US 2008/0099602 A1
(43) Pub. Date: May 1, 2008

(54) SYSTEM AND METHOD FOR DETECTING GROUND CONTACT STATUS OF AN AIR VEHICLE

(76) Inventors: Michael J. Zyss, Hacienda Heights, CA (US); Ashwani K. Chaudhary, Cypress, CA (US); David G. Childers, Long Beach, CA (US); Viet H. Nguyen, Cerritos, CA (US); David Poladian, Carlsbad, CA (US); Hoi T. Tran, Tustin, CA (US); Vincent L. Wong, Irvine, CA (US)

Correspondence Address: KLEIN, O'NEILL & SINGH, LLP, 43 CORPORATE PARK, SUITE 204, IRVINE, CA, 92606, US

(21) Appl. No.: 11/537,115

(22) Filed: Sep. 29, 2006

(51) Int. Cl. B64C 25/14

(52) U.S. Cl. 244/102 R

(57) ABSTRACT

A system and associated method for determining the ground contact status of an air vehicle. The system includes an altitude measurement device; at least one wheel speed sensor; at least one weight-on-wheel sensor; at least one squat switch and a processor for processing useful data from the altitude measurement device, the at least one wheel speed sensor, the at least one weight-on-wheel sensor and the at least one squat switch to manage the status of whether the air vehicle is in contact with the ground based on a ratio of the number of sensors providing useful data to the number of sensors available.

This invention was made with Government support under contract number F30602-03-C-2005 awarded by the U.S. Air Force. The government has certain rights in this invention.

### BACKGROUND

1. Field of the Invention

The invention is related to determining ground contact in an air vehicle, and more particularly to a system including wheel speed sensors and weight-on-wheel sensors, where data from these sensors combined with navigational commands, are processed with logic to handle failed sensors, to determine whether the air vehicle is in contact with the ground.

2. Related Art

Autonomous re-entry and unmanned autonomous vehicles (hereinafter, interchangeably, “UAV”) need a redundant fault tolerant system for establishing ground touchdown conditions. It is critical to properly switch between airborne mode and ground rollout mode so that the proper flight control system is used. The difficulty lies in producing a fault tolerant design that operates with minimum sensors, provide one fault tolerant system and operate in the presence of substantial physical uncertainties in the environment, sensors, effectors, and computing elements.

Accordingly, there is a need to provide a multi-element system design that solves all the foregoing challenges.

### SUMMARY

The present invention provides fault tolerant, integrated control of an air vehicle, such as a UAV while making a landing to allow the air vehicle to timely switch between an airborne mode and ground rollout mode.

The present invention allows the UAV to operate in the presence of substantial physical uncertainties in the environment, sensors, effectors, and computing elements. For example, the aircraft is capable of automatically determining when UAVs contact the ground (touchdown) under all weather conditions and numerous uncertainties.

The present invention uses a minimum number of switches in combination with wheel speed sensors to declare a touchdown event. In the event of one or more sensor failures the logic takes into consideration declared sensor failure events and can accommodate undeclared failures to declare the proper event.

In one aspect, a system is provided for determining the ground contact status of an air vehicle. The system includes at least one wheel speed sensor; at least one weight-on-wheel sensor; and a processor for processing useful data from the at least one wheel speed sensor, and the at least one weight-on-wheel sensor to manage the status of whether the air vehicle is in contact with the ground based on a ratio of the number of sensors providing useful data to the number of sensors available.

In another aspect of the invention, a method is provided for determining the ground contact status of an air vehicle. The method includes performing a sensor system check to determine the availability of sensors in a sensor suite; sensing a change in state in at least one sensor included in the sensor suite; and generating an indication of a result based on a ratio of sensors experiencing a change in state to the number of sensors available.

This brief summary is provided so that the nature of the invention may be understood quickly. A more complete understanding of the invention may be obtained by reference to the following detailed description of embodiments thereof in connection with the attached drawings.

### BRIEF DESCRIPTION OF THE DRAWINGS

The foregoing features and other features of the present invention are described with reference to the drawings. In the drawings, the same components have the same reference numerals. The illustrated embodiments are intended to illustrate, but not to limit the invention. The drawings include the following Figures:

FIG. 1 is a simplified schematic representation of an aircraft having a landing system in accordance with an embodiment of the present invention;

FIG. 2A is an illustration of a left side landing system and FIG. 2B is a relay coil associated with the left side landing system in accordance with an embodiment of the present invention;

FIG. 3 is a simplified illustration of a wheel including wheel speed sensors in accordance with an embodiment of the present invention; and

FIG. 4 is a flowchart showing a method in accordance with an embodiment of the present invention.

### DETAILED DESCRIPTION

The invention provides a fault tolerant system, which means that one or more sensor failures may occur in the system, however, the system, may still perform from a sensing point of view to make an accurate result determination.

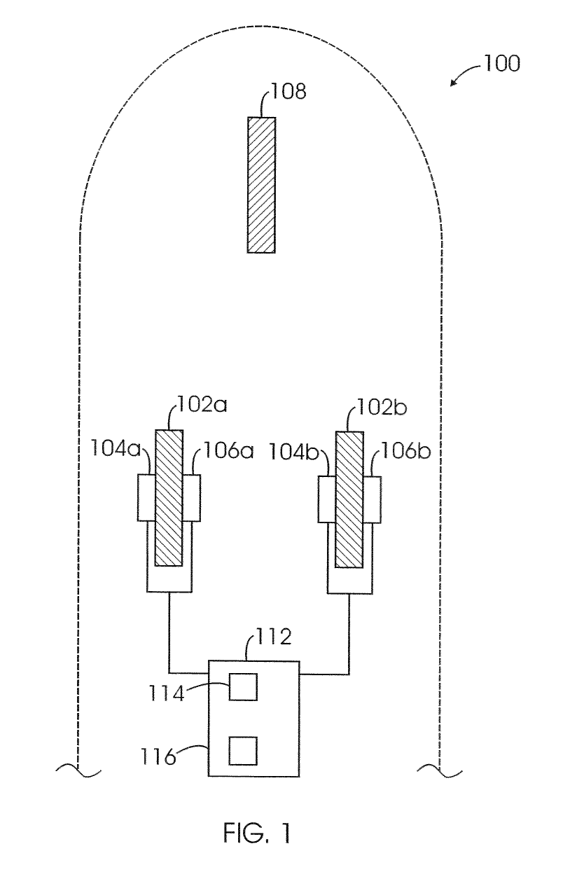

FIG. 1 is a simplified schematic representation of an aircraft 10, such as a UAV, including landing system 100 in accordance with an embodiment of the present invention.

Landing system 100 includes a conventional landing system, including main landing gear (MLG), nose landing gear and a control unit. The MLG and nose landing gear includes gears, brakes, wheels and other associated hardware as is well known in the art. In one embodiment, the MLG includes left wheel 102a and right wheel 102b, but may include any number or combination of wheels used for landing. The nose landing gear includes nose wheel 108.

Control unit 112 may include appropriate hardware that is capable of sensing and responding to operational signals or electrical pulses from various sensors. For example, control unit 112 may be an electronic board or an ASIC. In another embodiment, control unit 112 may include or may be coupled to a processing means 114, such as a microprocessor, a computer and the like, used to sense and respond to operational signals or electrical pulses from various sensors.

Control unit 112 is capable of detecting an MLG ground contact as a separate event from a nose landing gear ground contact. Control unit 112 also includes or is coupled to a sensor failure detection system 116, which provides a rate of sensor failures to processing means 114.

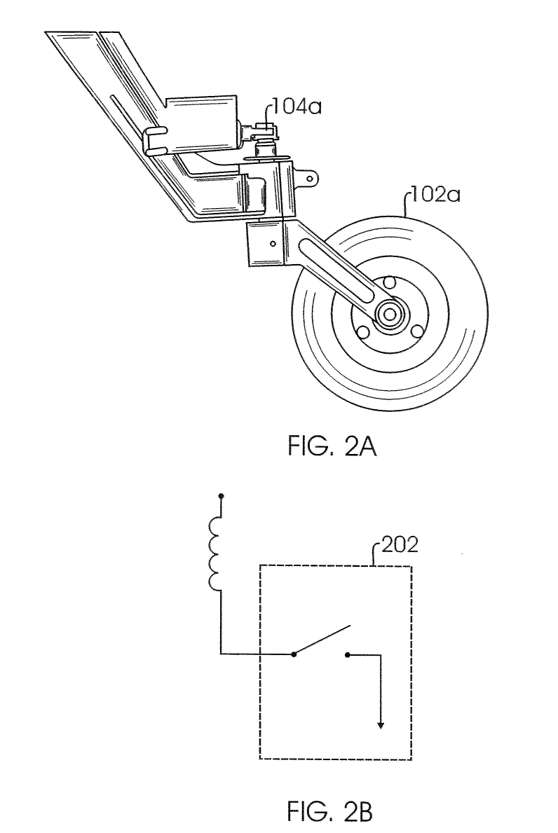

In one embodiment of the present invention, landing system 100 includes sensors, such as proximity switches; also know as “squat” switches or weight-on-wheel (WOW) sensors. In this embodiment, left wheel 102a includes a squat switch 104a (see also FIG. 2A) and right wheel 102b includes a squat switch 104b.

As shown in the example in FIGS. 2A and 2B, in operation, when UAV 10 is on the ground, squat switch 104a is open and the ground is removed from the return side of a squat relay coil 202. Alternatively, when UAV 10 is in the air, squat switch 104a is closed and a ground is supplied to the return side of the squat relay coil 202.

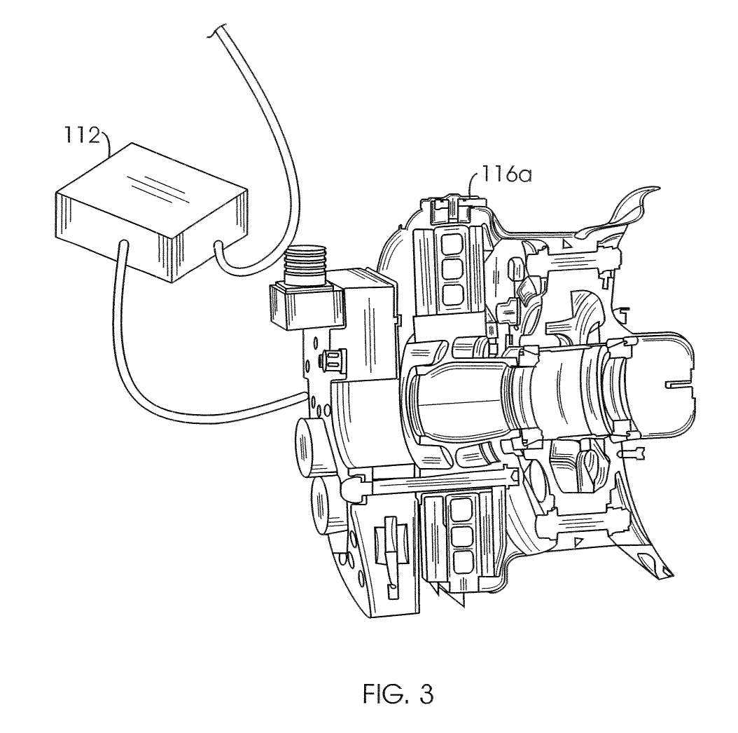

Referring again to FIG. 1, wheels 102a and 102b also include wheel speed sensors 106a and 106b, respectively (see also FIG. 3). Wheel speed sensors 106a and 106b are sender devices used for reading the speed of the vehicle's wheel rotation. In operation, wheel speed sensors 106a and 106b at each wheel 102a and 102b send electronic pulse signals to control unit 112. Control unit 112 senses the rotation speed of wheels 102a and 102b.

Hereinafter, squat switches 104a and 104b and wheel speed sensors 106a and 106b are sometimes referred to collectively as the “sensors.”

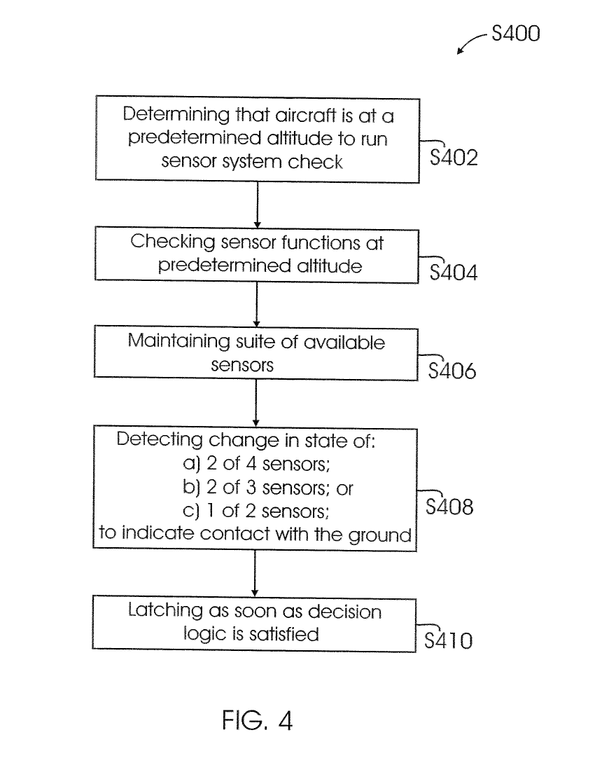

FIG. 4 is a flowchart describing an operational embodiment s400 of the present invention. In operation, an altitude sensor (not shown) is used to determine that aircraft 10 at a predetermined height above the ground (s402).

The altitude sensor may be any suitable altitude sensor, such as an inertial measurement sensor, as is well known in the art. In one embodiment, the predetermined height can be any height before wheels 102a and 102b make contact with the ground, such as between 5 and 30 ft, for example, at 10 ft above the ground.

In s404, at the predetermined height above ground squat switches 104a and 104b and wheel speed sensors 106a and 106b are checked or tested to determine if the sensors are functioning properly. For example, squat switches 104a and 104b should be indicating that no contact has been made between wheels 102a and 102b and the ground. Speed sensors 106a and 106b should be indicating wheel rotation speeds of zero or a value below a preset threshold.

In s406, sensors that are working properly are added to the suite of available sensors. In the event that one or more of the sensors is not functioning properly then that one or more sensor is removed from the suite of available sensors used for determining if ground contact has been made.

In s408, processing means 114 includes a redundancy management scheme used to determine the status of the suite of available sensors to determine whether UAV 10 is in contact with the ground (“wheels down”) based on a rate of sensor failures. In one embodiment, if all four sensors 104a, 104b, 106a, and 106b are available in the suite, then signals indicating a “change in state” are needed from only two sensors, in any combination, to indicate wheels down.

In one embodiment, if the suite includes only three sensors, then signals indicating a “change in state” are needed from only two of the three sensors, in any combination, to indicate wheels down.

In one embodiment, if the suite includes only two sensors, then signals indicating a “change in state” are needed from only one of the two sensors, in any combination, to indicate wheels down.

In s410, although the squat switches 104a and 104b and the wheel speed sensors 106a and 106b are being continuously monitored (sampled) by control unit 112 during the landing operation, once the above described decision logic has been met, a wheels down indication is made and the control unit 112, causes UAV 10 to switch to ground mode operation.

In one embodiment, if the suite of available sensors is empty then a timer (not shown) is used to determine wheels down after control unit 112 senses that a predetermined amount of time has passed from a discrete event, such as the altitude check in s402.

Although the present invention is described with reference to specific embodiments, these embodiments are illustrative only and are not limiting. Many other applications and embodiments of the present invention will be apparent in light of this disclosure and the following claims.

What is claimed is:

1. A system for determining the ground contact status of an air vehicle, the system comprising:
at least one wheel speed sensor;
at least one weight-on-wheel sensor;
at least one squat switch; and
a control unit for controlling said air vehicle in response to data received from said at least one wheel speed sensor, said at least one weight-on-wheel sensor and said at least one squat switch to manage the status of said air vehicle.

2. The system of claim 1, wherein said control unit further includes a processor for processing said data.

3. The system of claim 2, wherein said processor further comprises detecting a main gear ground contact and nose gear ground contact as separate events.

4. The system of claim 2, wherein said processor manages the status of whether said air vehicle is in contact with the ground based on a ratio of the number of sensors providing useful data to the number of sensors available.

5. The system of claim 1, further comprising a sensor failure detection system, wherein said sensor failure detection system provides a rate of sensor failures.

6. The system of claim 1, wherein said control unit comprises an ASIC.

7. A method for determining the ground contact status of an air vehicle, the method comprising:
providing a suite of sensors;
performing a sensor system check to determine the availability of sensors in the sensor suite;
sensing a change in state in at least one sensor included in the sensor suite; and
generating an indication of a result based on a ratio of sensors experiencing a change in state to the number of sensors available.

8. The method of claim 7, wherein performing a sensor system check comprises performing a sensor system check when a vehicle including the sensor suite is at a predetermined altitude.

9. The method of claim 7, wherein the sensor suite comprises at least one wheel speed sensor; at least one weight-on-wheel sensor; at least one squat switch.

10. The method claim 9, wherein a no change in state indication indicates ground contact after a predetermined time.
